(19) United States
(12) Patent Application Publication
(10) Pub. No.: US 2003/0194196 A1
(43) Pub. Date: Oct. 16, 2003

(54) Fiber array base block for fiber array module and method for fixing optical fibers to the fiber array base block

(75) Inventors: Chung-I Chiang, Taoyuan (TW); Ming-Jen Wang, Tucheng City (TW); Kun-Hsien Cheng, Jungli City (TW); Hong-Jueng King, Taoyuan (TW); Huei-Pin Huang, Taoyuan (TW); Chwei-Jing Yeh, Sanchung City (TW)

Correspondence Address: BACON & THOMAS, PLLC, 625 SLATERS LANE, FOURTH FLOOR, ALEXANDRIA, VA, 22314

(73) Assignee: RiTek Corporation, Hsinchu (TW)

(21) Appl. No.: 10/411,258

(22) Filed: Apr. 11, 2003

(30) Foreign Application Priority Data
Apr. 12, 2002 (TW) 91107517

(51) Int. Cl. G02B 6/00

(52) U.S. Cl. 385/137

(57) ABSTRACT

A fiber array base block is disclosed for the positioning at least one optical fiber for making a fiber array module, the fiber array base block having parallel grooves in one side for the positioning of optical fibers, and at least one channel disposed below and intersected with the grooves and adapted for producing a vacuum suction force to secure the optical fibers in the grooves as air drawn away from the channel channels.

### BACKGROUND OF THE INVENTION

1. Field of the Invention

The present invention relates to a fiber array base block and, more particularly, to such a fiber array base block, which is adapted for manufacturing an optical communication fiber array module.

2. Description of Related Art

Optical communication technology is well developed recently because of the great need for high-speed communication. In optical communication, optical fibers are frequently attached to or bonded to other optical communication devices and arranged in arrays for transmitting signal to achieve big volume of data at a high speed. In most cases, a fiber array module, as shown in FIG. 1, comprises a fiber array base block 300 having grooves 310, and a plurality of optical fibers 350 fixedly mounted in the grooves 310 of the fiber array base block 300. The grooves 310 are adapted to ensure the aligned angle and pitch of the optical fibers 350. However, because optical fibers are thin and not easy to control, it is difficult to align these optical fibers in the grooves of the fiber array base block. This problem is more apparent when filling the binders such as adhesives, solders, or photo-curing resins in the grooves. In order to position optical fibers in the grooves of the fiber array base block smoothly and accurately, the viscosity of the binders must be strictly controlled. However, strictly controlling the viscosity of binders limits the selection of usable binders. Furthermore, because controlled operation of optical fibers in the grooves is uneasy, it is difficult to examine the positions of optical fibers accurately before curing.

Therefore, it is desirable to provide “fiber array base block for fiber array module and method of fixing optical fibers to the fiber array base block” that eliminates the aforesaid drawbacks.

### SUMMARY OF THE INVENTION

A main object of the present invention is to provide a fiber array base block for manufacturing a fiber array module, which simplifies the procedure for fixing optical fibers to the fiber array base block, so as to save the time for fixing optical fibers on a fiber array base block, and further to increase fiber array module yield.

To achieve this objects of the present invention, the fiber array base block for positioning at least one optical fiber to make a fiber array module, comprises a substrate having a plurality of grooves locating on a first surface thereof and at least one channel embedded inside said substrate; wherein said grooves extend from a first side edge of said first surface of said substrate to a second side edge thereof opposite to said first side edge to position said optical fibers, said channel disposed between said grooves and a second surface opposite to said first surface, said channel connects with said grooves, and each groove intersects with at least one of said channels.

The method of the present invention for fixing optical fibers to a fiber array base block comprises the steps of (a) providing at least one bundle of optical fibers, a binder, and a fiber array base block, wherein said fiber array base block comprises a substrate having a plurality of grooves locating on a first surface thereof and at least one channel embedded inside said substrate, said grooves extends from a first side edge thereof to a second side edge thereof opposite to said first side edge to position said optical fibers, said channel disposed between said grooves and a second surface opposite to said first surface, said channel connects with said grooves, and each groove intersects with at least one of said channels; (b) drawing air out of said channel to secure said optical fibers to said grooves through suction; and (c) adding and curing said binder to fasten said optical fibers to said grooves.

Other objects, advantages, and novel features of the invention will become more apparent from the following detailed description when taken in conjunction with the accompanying drawings.

### BRIEF DESCRIPTION OF THE DRAWINGS

FIG. 1 illustrates a fiber array module constructed according to the prior art.

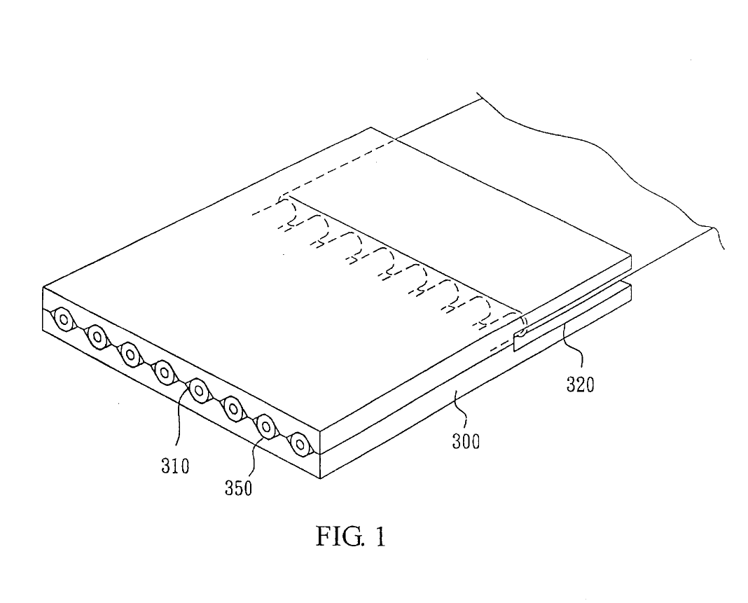

FIG. 2 illustrates a fiber array module constructed according to the present invention.

FIG. 3 is a cutaway view of the fiber array module shown in FIG. 2.

FIG. 4 is a cutaway view of the fiber array base block according to the present invention.

### DETAILED DESCRIPTION OF THE PREFERRED EMBODIMENT

The grooves on the fiber array base block of the present invention can be grooves in any shape. Preferably, the grooves on the fiber array base block of the present invention are grooves have a V-shaped or a U-shaped cross-section. The method for forming the grooves on the fiber array base block of the present invention can be any conventional method for forming grooves. Preferably, the grooves on the fiber array base block of the present invention are formed through knife cutting, molding or chemical etching. The channels on the fiber array base block of the present invention can be used for extracting or exhausting air. Especially when the optical fibers are ready to be fixed on the fiber array base block, a difference of air pressure or partial vacuum forms by the air extracting through the channels. Thus the difference (or the gradients) of air pressure assists the absorption and the fixing of the optical fibers in the grooves of the fiber array base block of the present invention. The change of the pressure gradient made through the help of the air extracting of the channels simplifies the process and save the time for fixing optical fibers on the fiber array base block. The channels of the fiber array base block of the present invention can be any kinds of channels embedded inside the fiber array base block of the present invention or channels (or grooves) disposed in a second surface of said fiber array base block opposite to said first surface having the grooves for locating optical fibers. Preferably, the channels are perpendicularly extended across said grooves. The vertical distance between each channel and the bottom of the grooves of the fiber array base block of the present invention can be any distance. Preferably, the channel can even intersect with the grooves of the fiber array base block. Each groove of the fiber array base block of the present invention can selectively connect at least one channel through holes or pores inside the fiber array base block. The angles between the channels and the grooves of the fiber array base block of the present invention can be any angle. Preferably, the channels are perpendicularly extended across said grooves. The arrangement of the grooves on the fiber array base block can be any arrangement. Preferably, grooves on the fiber array base block are parallel to each other. The distance between two neighboring grooves is not limited. Preferably, the distance between any two neighboring grooves is not less than the diameter of the optical fibers. The arrangement of the channels of the fiber array base block of the present invention can be any arrangement. Preferably, the channels are parallel to each other. The shape of the channel of the fiber array base block of the present invention can be in any shape. Preferably, the channel of the fiber array base block of the present invention has a triangle-shape, rectangle-shape or circle-shape cross-section. The fiber array base block of the present invention can selectively further comprises a cover plate for covering said first surface. Preferably, the cover plate can selectively be formed a plurality of top grooves corresponding to said grooves on said first surface to form spaces for positioning or receiving said optical fibers.

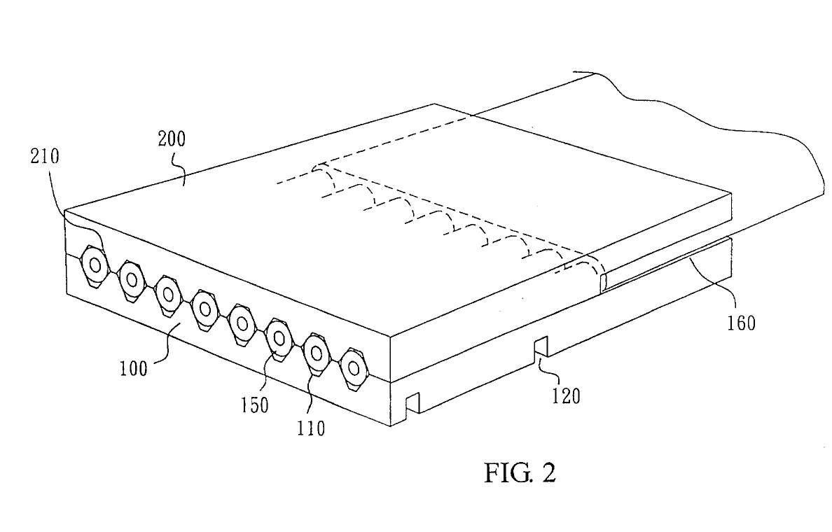

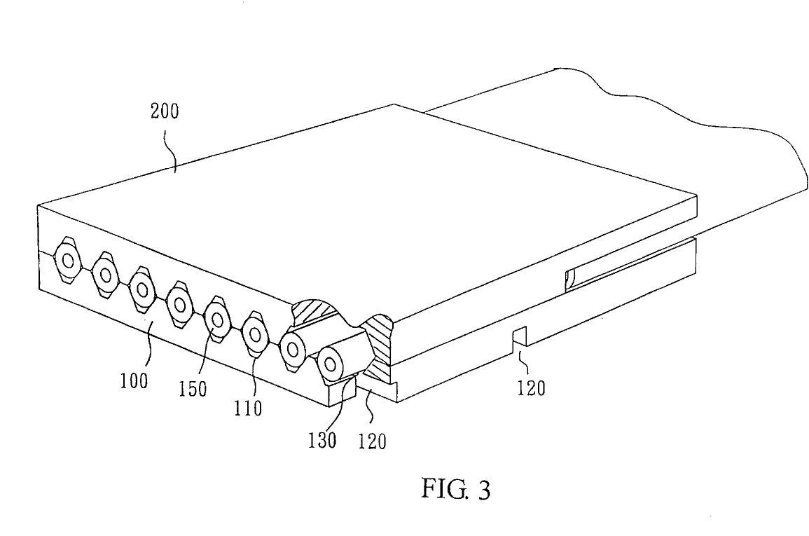

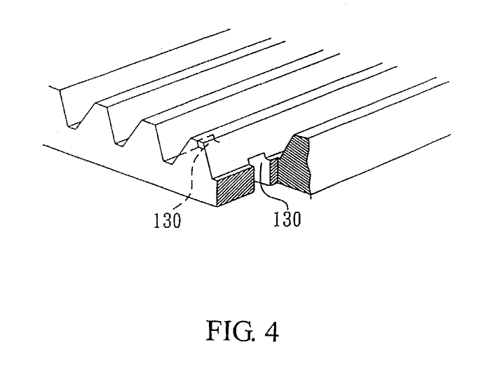

With reference to FIGS. 2, 3, and 4, the fiber array base block, referenced by 100, has a plurality of V-grooves 110 and channels 120 embedded in the fiber array base block 100. The V-grooves 110 are arranged in parallel in the top sidewall of the fiber array base block 100 and are adapted for holding optical fibers 150. The V-grooves 110 are all in the same width, and are extended from one side edge of the fiber array base block 100 to an opposite side edge (or the edge of a step) of the fiber array base block 100. The channels 120 of the fiber array base block 100 locate below the V-grooves 110. The depth (from the surface of the fiber array base block 100) of the channels 120 is in a range between the depth of the bottom surface (from the surface of the fiber array base block 100) and that of the V-grooves 110 (see FIG. 4). An opening 130 is formed in each intersected area between the channels 120 and the V-grooves 110. The channels 120 can also optionally be formed in the bottom sidewall of the fiber array base block 100 and extended from one side edge of the fiber array base block 100 to an opposite side edge thereof. The channels 120 are mounted perpendicularly across the bottom of the V-grooves 110. Furthermore, a cover plate 200 having top V-grooves 210 may be selectively introduced and covered on the fiber array base block 100 as it is demanded(see FIGS. 2 and 3). The top V-grooves 210 of the cover plate 200 used here are match to the V-grooves 110 of the fiber array base block 100 to form spaces for mounting the optical fibers 150.

When using the fiber array base block 100 for fixing the optical fibers 150, the optical fibers 150 are respectively arranged in the V-grooves 110 of the fiber array base block 100, and at the same time air is drawn away from the channels 120. The vacuum produced in the openings 130 and the channels 120 further helps to suck the optical fibers 150 in the V-grooves 110, and therefore the optical fibers 150 are respectively positively secured to the V-grooves 110. Thereafter, a binder is filled in the V-grooves 110. Then the top cover 200 is covered on the fiber array base block 100 to hold the optical fibers 150 in the V-grooves 110, and the binder is furthermore cured by radiation or heating. The binder used here can be photosensitive resin or solder. In the present embodiment, photosensitive resin is used. The binders can be selectively applied to the outside layer of each optical fiber 150 before laying the optical fibers 150 in the V-grooves 110 of the fiber array base block 100.

According to the present invention, a negative pressure is employed to the channels and openings of the fiber array base block for quick arrangement and alignment of the optical fibers in the V-groove of the fiber array base block. This method enables that the positions of the optical fibers can be examined before curing of the binders. Moreover, because the optical fibers are secured to the V-grooves of the fiber array base block by a suction force before curing of the bonding agent, a wide range of binders can be selectively used.

Although the present invention has been explained in relation to its preferred embodiment, it is to be understood that many other possible modifications and variations can be made without departing from the spirit and scope of the invention as hereinafter claimed.

What is claimed is:

1. A fiber array base block for positioning at least one optical fiber to make a fiber array module, comprising:
a substrate having a plurality of grooves locating on a first surface thereof and at least one channel embedded inside said substrate; wherein said grooves extend from a first side edge of said first surface of said substrate to a second side edge thereof opposite to said first side edge to position said optical fibers, said channel disposed between said grooves and a second surface opposite to said first surface, said channel connects with said grooves, and each groove intersects with at least one of said channels.

2. The fiber array base block as claimed in claim 1, wherein said grooves have a V-shaped or a U-shaped cross-section.

3. The fiber array base block as claimed in claim 1, wherein said channels are disposed in a second surface of said fiber array base block opposite to said first surface.

4. The fiber array base block as claimed in claim 1, wherein said channels are perpendicularly extended across said grooves.

5. The fiber array base block as claimed in claim 1, wherein said grooves are parallel to each other.

6. The fiber array base block as claimed in claim 1, wherein at least one channel intersects with all of said grooves.

7. The fiber array base block as claimed in claim 1 further comprising a cover plate for covering said first surface, wherein said cover plate has a plurality of top grooves corresponding to said grooves on said first surface to form spaces for positioning or receiving said optical fibers.

8. The fiber array base block as claimed in claim 1, wherein said channels are in parallel.

9. A method of fixing optical fibers onto a fiber array base block comprising the steps of:
(a) providing at least one optical fiber, a binder, and a fiber array base block, wherein said fiber array base block comprises a substrate having a plurality of grooves locating on a first surface thereof and at least one channel embedded inside said substrate, said grooves extend from a first side edge thereof to a second side edge thereof opposite to said first side edge to position said optical fibers, said channel disposed between said grooves and a second surface opposite to said first surface, said channel connects with said grooves, and each groove intersects with at least one of said channels;
(b) drawing air out of said channel to secure said optical fibers to said grooves through suction; and
(c) adding and curing said binders to fasten said optical fibers to said grooves.

10. The method as claimed in claim 9, further comprising a sub-step (b2) of providing a cover plate having top grooves corresponding to the grooves of said fiber array base block and covering said cover plate on said fiber array base block after said step (b) before said step (c).

11. The method as claimed in claim 9, wherein said grooves have a V-shaped or a U-shaped cross-section.

12. The method as claimed in claim 9, wherein said binders are covered on the surface of each optical fiber.

13. The method as claimed in claim 9, wherein said binders covered on the periphery of each of said grooves.

14. The method as claimed in claim 9, wherein at least one channel is disposed in a second surface of said fiber array base block opposite to said first surface of said fiber array base block.

15. The method as claimed in claim 9, wherein at least one channel is perpendicularly extended across said grooves.

16. The method as claimed in claim 9, wherein said grooves are in parallel.

17. The method as claimed in claim 9, wherein at least one channel intersects with all of said grooves.

18. The method as claimed in claim 9, wherein said channels are in parallel.

19. The method as claimed in claim 9, wherein said binder is a photosensitive resin.

20. The method as claimed in claim 9, wherein said binder is a solder.
